(19) United States
(12) Patent Application Publication
(10) Pub. No.: US 2021/0164496 A1
(43) Pub. Date: Jun. 3, 2021

(54) IMPROVED SYSTEM FOR STORING AND HARVESTING ENERGY

(71) Applicant: IFP Energies nouvelles, Rueil-Malmaison (FR)

(72) Inventors: Patrick BRIOT, POMMIER DE BEAUREPAIRE (FR); David TEIXEIRA, CROISSY-SUR-SEINE (FR)

(21) Appl. No.: 16/771,023

(22) PCT Filed: Nov. 14, 2018
(86) PCT No.: PCT/EP2018/081167

§ 371 Date: Jun. 9, 2020

(30) Foreign Application Priority Data
Dec. 11, 2017 (FR) 17/61.917

(51) Int. Cl. F15B 1/027

(52) U.S. Cl. CPC F15B 1/027

(57) ABSTRACT

The invention relates to a system and to a method for compressed-gas energy storage and recovery comprising at least a first and at least a second heat exchanger, a cold liquid storage means and a hot liquid storage means.

The first heat exchangers comprise at least one heat exchanger without direct contact, and at least one second heat exchanger is a direct-contact heat exchanger.

### FIELD OF THE INVENTION

The present invention relates to the field of energy storage and production by air compression and expansion.

### BACKGROUND OF THE INVENTION

Electricity production from renewable energies, for example by means of solar panels, or onshore or offshore wind turbines, is booming. The main drawbacks of these production means are intermittent production and possible mismatch between the production period and the consumption period. It is therefore important to have a means of storing energy during production so as to release it during a consumption period.

There are many technologies allowing this balance to be achieved.

The best known of them is the Pumped Storage Plant (PSP) using two water reservoirs at different elevations. The water is pumped from the lower basin to the upper basin during the charging phase. The water is then sent to a turbine, towards the lower basin, during discharge.

Using batteries of different types (lithium, nickel, sodium-sulfur, lead-acid, etc.) can also meet this energy storage requirement.

Another technology, Flywheel Energy Storage (FES), consists in accelerating a rotor (flywheel) to a very high speed and in maintaining the energy in the system in form of kinetic energy. When energy is extracted from the FES system, the rotational speed of the flywheel is reduced as a consequence of the energy conservation principle. Adding energy to the FES system therefore causes an increase in the flywheel speed.

The energy storage technology using compressed gas (often compressed air) is promising. The produced energy that is not consumed is used for compressing air to pressures ranging between 40 bars and 200 bars using (possibly multi-stage) compressors. Upon compression, the air temperature increases. In order to limit the cost of the storage tanks and to minimize the electricity consumption of the compressor, the air can be cooled between each compression stage. The compressed air is then stored under pressure, either in natural cavities (caves) or in artificial reservoirs.

During the electricity production phase, the stored air is then sent to turbines so as to produce electricity. Upon expansion, the air cools down. In order to avoid too low temperatures (−50° C.) causing damage to the turbines, the air can be heated prior to expansion. Such plants have been operating for a number of years now, such as for example the Huntorf plant in Germany, since 1978, or the Macintosh plant in the USA (Alabama), since 1991. These two plants have the particular feature of using the stored compressed air for feeding gas turbines. These gas turbines burn natural gas in the presence of air under pressure in order to generate very hot combustion gases (550° C. and 825° C.) at high pressure (40 bars and 11 bars) prior to expanding them in turbines generating electricity. This type of process emits carbon dioxide. The Huntorf plant could emit approximately 830 kg CO₂ per megawatt of electricity produced.

There is a variant under development. It is a so-called adiabatic process wherein the heat resulting from the compression of air is recovered, stored and released to the air prior to expansion thereof. It is the technology known as AACAES (Advanced Adiabatic Compressed Air Energy Storage).

In this technology, the air is often air taken from the surrounding medium. It may therefore contain water in vapour form. This humidity varies depending on the geographic location and the temperature and/or the season. Upon cooling of the air after compression, the water contained in the air may condense totally or partly. When it is not removed from the gas, the water contained in the gas can cause damage to the compressors and other equipments in which the compressed gas circulates.

What is referred to as “compression line” is the gas line connecting the gas inlet to the compressed gas storage means and passing through at least one compression means.

What is referred to as “expansion line” is the gas line connecting the compressed gas storage means to the gas outlet and passing through at least one expansion means.

Heat exchangers are used for cooling and/or heating the air. There are several heat exchanger technologies.

Among them, several types of heat exchanger allow exchanges between two fluids (often a gas and a liquid). These exchangers allow a hot gas to be cooled from a cold fluid (often a cold liquid) or a cold gas to be heated from a hot fluid (often a hot liquid).

Direct-contact heat exchangers are understood to be heat exchangers wherein direct contact occurs between a fluid (often liquid) and a gas. When direct-contact heat exchangers are used, matter exchanges may also take place between the fluid and the gas.

When direct-contact heat exchangers are used, the gas can become partly laden with fluid in form of gas or liquid droplets and/or part of the gas can condense or be absorbed by the fluid. This depends both on the fluid, the gas, the pressures and temperatures, as well as the exchange mode (gas heating or cooling). It may therefore be necessary to add fluid into the circuit or, on the contrary, to extract some, thus complexifying the system.

Heat exchangers without direct contact are understood to be heat exchangers wherein no direct contact occurs between the fluid and the gas. In this type of heat exchanger without direct contact, heat exchange occurs for example through a solid wall, but no matter transfer can take place between the fluid and the gas. Plate exchangers or shell-and-tube exchangers are examples of heat exchangers without direct contact.

Another heat exchanger technology is based on heat storage and release particles. In this type of heat exchanger, an enclosure is filled with a so-called fixed bed of heat storage and release particles. The heat storage and release particles are solid elements made from a material with good properties for storing and releasing heat. These particles are randomly arranged in the bed. A fixed bed is understood to be a bed where the particles are not set in motion deliberately. They may however undergo motions induced by thermal expansions or by the gas circulation within the enclosure for example. In this type of exchanger, referred to as Thermocline hereafter, the gas circulates in the enclosure through the fixed bed of heat storage and release particles:
either the gas heats the heat storage and release particles,
or the gas is, on the contrary, heated by the heat storage and release particles.

In these Thermocline type exchangers, the gas and the heat storage and release particles thus exchange heat directly (no use of an intermediate fluid such as a liquid for example).

Upon compression of the gas, the air temperature rises. In order to avoid storing the compressed air at a high temperature generating an extra cost for the storage means, the heat of the air is recovered and the air is thus cooled.

Patent US-2013/0,042,601 describes air cooling between the compression stages by water through exchangers without direct contact. The hot water is subsequently cooled. The heat required during expansion is provided by hydrocarbon combustion in high-pressure and low-pressure burners. A similar description is made in patents US-2014/0,026,584 A1 and US-2016/0,053,682 A1. Using a combustion chamber and hydrocarbons involves the following disadvantages: high cost of the combustion chamber and significant CO₂ emissions.

In patents US-2011/0,113,781 A1 and WO-2016/0,749,485 A1, the heat resulting from the compression of the air is used to feed parallel Rankine and/or Kalina cycles based on the use of butane, pentane, isopentane. The heat required upon expansion of the air is provided by an outer source (burners, etc.). In this case, the cost of the burners and of the use of flammable gas is also high. Furthermore, these solutions cause pollution.

Patent WO-2016/012,764 A1 describes a heat exchange without direct contact between hot air resulting from compression and a molten salt using heat exchangers. The air is heated prior to expansion by means of the previously obtained hot molten salt. Such a system is also used in patent DE-10-2010/055,750 A1, where the fluid used for transferring the compression heat to expansion is a saline water solution through exchangers. Using molten salts or a saline solution involves a drawback for the design of the equipments due to the corrosion risk. Besides, implementing these solutions using phase-change materials is complex.

Cooling of the air can also be done by means of so-called direct-contact exchangers, which may be, for example, packed columns with structured or random packing, or tray columns. The hot air is sent into a column wherein a cold liquid is sent counter-current to the air. The heat of the air is then transferred to the cold fluid that heats up on contact with the air. In addition to the heat, matter transfers may also occur upon contact. These columns generally contain elements allowing contact between the gas phase (air) and the liquid phase (cold fluid) to be improved, so as to facilitate gas-liquid transfer. These elements may be structured or random packings, or distributor trays equipped with chimneys. There are also direct-contact systems based on solids. Patent US-2016/0,326,958 A1 describes a system where heat transfer occurs through direct contact with phase-change materials. Patent US-2011/0,016,864 A1 uses a heat transfer technology through direct contact with molten salts. In this case, direct-contact heat exchanges occur on the compression line and on the expansion line. On the compression line, this involves the drawback of loading the gas with liquid or solid likely to damage the rest of the system. Besides, implementation of solutions using phase-change materials is complex.

To minimize the material cost, the same equipments can be used for cooling the hot air from compression and for heating the air before expansion because the process operates in a cyclic manner. This is described in patent DE-10-2010/055,750 A1 for the technology without direct contact, and in patents US-2011/0,016,864 A1 and US-2016/0,326,958 A1 for the direct-contact heat exchange technology.

The various solutions of the state of the art do not provide optimum efficiency, notably because of the heat exchanges.

In order to overcome the aforementioned drawbacks of the prior art, the present invention relates to a compressed-gas energy storage and recovery system and method, improved by using:
at least one heat exchanger without direct contact, on the compression line, downstream from the compression means,
at least one direct-contact heat exchanger, positioned on the expansion line, upstream from the expansion means.

Using a mix of heat exchangers with and without direct contact allows the efficiency of the system to be optimized.

### SUMMARY OF THE INVENTION

The invention relates to a compressed-gas energy storage and recovery system comprising:
at least one gas compression means,
at least one means of storing said compressed gas,
at least one means of expanding said compressed gas so as to generate an energy,
at least a first heat exchanger, said first heat exchanger being arranged downstream from said means of compressing said compressed gas,
at least a second heat exchanger, said second heat exchanger being arranged upstream from said means of expanding said compressed gas,
at least one cold liquid storage means and at least one hot liquid storage means.

Said first heat exchangers comprise at least one heat exchanger without direct contact and at least one second heat exchanger is a direct-contact heat exchanger. Said direct-contact heat exchangers and said heat exchangers without direct contact transfer heat between said gas and said liquid. Said direct-contact heat exchangers and said heat exchangers without direct contact are positioned between said cold liquid storage means and said hot liquid storage means.

Preferably, said gas is air.

Advantageously, said liquid is water.

According to an implementation of the invention, said first heat exchangers are all heat exchangers without direct contact between said liquid and said gas.

According to a variant embodiment of the invention, the system comprises at least one heat exchanger with a fixed bed of heat storage particles, said heat exchanger with a fixed bed of heat storage particles being configured to be both a first and a second heat exchanger.

According to a variant of the invention, said second heat exchangers are all heat exchangers with direct contact between said liquid and said gas.

According to an implementation of the invention, said second heat exchangers comprise direct-contact heat exchangers and heat exchangers without direct contact, said second direct-contact heat exchangers being positioned among the last heat exchangers.

According to an embodiment of the invention, the heat exchangers without direct contact are (welded or not) plate exchangers and/or shell-and-tube exchangers.

According to a variant of the invention, the direct-contact heat exchangers are packed columns and/or tray columns.

According to an embodiment of the invention, the system comprises at least one means of separating said gas and said liquid, said separation means being positioned after at least one first heat exchanger.

Advantageously, several gas compression means and/or several means of expanding said gas are used, preferably at least three.

Preferably, several first heat exchangers are used, preferably at least a first heat exchanger after each of said compression means.

Advantageously, several separation means are used, preferably at least one separation means after each of said first heat exchangers.

Preferably, several second heat exchangers are used, preferably at least a second heat exchanger upstream from each of said expansion means.

The invention also relates to an energy storage and recovery method wherein the following steps are carried out:
a) compressing a gas,
b) cooling a compressed gas by heat exchange with a cold liquid and storing the hot liquid at the heat exchanger outlet,
c) storing said cooled compressed gas,
d) heating said cooled compressed gas by means of a heat exchanger using the hot liquid stored in step c) and storing said cold liquid,
e) expanding said compressed gas.

At least one heat exchange carried out in step b) occurs without direct contact between the liquid and the gas, and at least one heat exchange carried out in step d) occurs at least partly by direct contact between the liquid and the gas.

Advantageously, said gas is air.

Preferably, said liquid is water.

Preferably, between step b) and step c), step b-bis) consisting in separating said cooled compressed gas and said condensed liquid is carried out, and said condensed liquid is stored.

Advantageously, at least one of steps a), b) and/or b-bis) is carried out several times prior to moving on to the next step.

Preferably, at least one of steps d) and e) is carried out several times.

According to a variant of the method according to the invention, each heat exchange of step d) between said liquid and said gas occurs by direct contact between the liquid and the gas.

According to an implementation of the method of the invention, the heat exchanges of step d) between the liquid and the gas occur by means of direct-contact heat exchangers and heat exchangers without direct contact, the direct-contact heat exchangers being positioned among the last heat exchangers.

According to a variant of the method, at least one heat exchange of step b) and at least one heat exchange of step d) are replaced by a heat exchange between a fixed bed of heat storage particles and said gas, the heat of said compressed gas being stored in said heat storage particles during at least one step b), the stored heat of said heat storage particles being released to the compressed gas during at least one step d).

According to a variant of the method of the invention, the heat exchange without direct contact of step b) occurs by means of at least one (welded or not) plate exchanger or of at least one shell-and-tube exchanger.

According to an implementation of the method according to the invention, the direct-contact heat exchange of step d) occurs at least partly through a packed column or a tray column.

### BRIEF DESCRIPTION OF THE FIGURES

Other features and advantages of the system and of the method according to the invention will be clear from reading the description hereafter of embodiments given by way of non-limitative example, with reference to the accompanying figures wherein:

FIG. 1 illustrates an example of an energy storage and recovery system according to the prior art,

FIG. 2 illustrates a second example of an energy storage and recovery system according to the prior art,

FIG. 3 illustrates a third example of an energy storage and recovery system according to the prior art,

FIG. 4 illustrates a first embodiment of an energy storage and recovery system according to the invention,

FIG. 5 illustrates a second embodiment of an energy storage and recovery system according to the invention.

### DETAILED DESCRIPTION OF THE INVENTION

The invention relates to a compressed-gas energy storage and recovery system comprising:
at least one gas compression means allowing the pressure of the gas to be increased for storage purposes,
at least one compressed gas storage means for storing the compressed gas to be used at a later time,
at least one compressed gas expansion means for generating energy,
at least a first heat exchanger, the first heat exchanger being arranged downstream from the gas compression means and allowing the gas to be cooled after compression thereof,
at least a second heat exchanger, the second heat exchanger being positioned upstream from the compressed gas expansion means and allowing the gas to be heated prior to expansion thereof, in order to operate the expansion means at a temperature providing optimum efficiency,
at least one cold liquid storage means and at least one hot liquid storage means, these means enabling use of cold liquid for at least a first heat exchanger and use of hot liquid for at least a second heat exchanger.

The first heat exchangers comprise at least one heat exchanger without direct contact, on the one hand in order to optimize heat recovery and, on the other hand, to limit the risks of presence of liquid in the gas. Indeed, heat exchangers without direct contact do not enable matter exchange between the liquid and the gas. Thus, the only traces of liquid possibly present in the gas are related to the condensation thereof. Using direct-contact heat exchangers for the first heat exchangers could drive part of the heat transfer liquid into the gas, which liquid would add up to the condensation. Thus, means for separating the liquid and the gas would be most useful, considering the significant amount of water that would then be integrated into the gas.

Besides, at least a second heat exchanger is a direct-contact heat exchanger. Using a direct-contact heat exchanger in the expansion line is interesting in terms of system performance. Indeed, when this type of exchanger is used, matter exchanges occur between the gas and the liquid: part of the liquid is then dissolved in the gas, thus increasing the density and the mass flow rate thereof. These characteristics allow the efficiency regarding the expansion means to be increased.

Direct-contact heat exchangers and heat exchangers without direct contact transfer heat between the gas and the liquid. These exchangers provide good thermal performances, easy to implement. Besides, the pressure drops generated by these systems are relatively low. The direct-contact heat exchangers and the heat exchangers without direct contact are positioned between the cold liquid storage means and the hot liquid storage means. The liquid is thus stored hot and cold, with a view to later use.

Preferably, the gas may be air, and preferably air taken from the ambient medium. Thus, the costs related to gas production, conditioning and logistics are eliminated.

Preferably, the liquid may be water. Indeed, water is an inexpensive heat transfer fluid, which is an excellent compromise.

According to an implementation of the system according to the invention, the first heat exchangers can all be heat exchangers without direct contact between the liquid and the gas. Thus, the system is simplified by a single technology of heat exchangers to be used on the compression line.

According to another embodiment of the invention, the system comprises at least one heat exchanger with a fixed bed of heat storage particles. This heat exchanger with a fixed bed of heat storage particles, known as Thermocline, is then configured to be both a first and a second heat exchanger. In this exchanger, the gas and the heat storage particles exchange heat directly, and the gas circulates through the fixed bed of heat storage particles. Indeed, the particle bed being fixed, the heat coming from the hot compressed gas and absorbed by the storage particles is then released by these storage particles to the gas circulating in the exchanger. In other words, the exchanger is used here both as a first and as a second heat exchanger. This allows to simplify the system and to reduce the cost by limiting the number of exchangers, and by limiting the pipes and the throttling/pumping systems required for technologies relative to exchanges between a gas and another fluid (direct-contact heat exchangers and heat exchangers without direct contact for example). Besides, the heat storage particles can be made from inexpensive materials.

According to a variant of the invention, the second heat exchangers can all be heat exchangers with direct contact between the liquid and the gas. This implementation allows the expansion line to be simplified by means of a single heat exchanger technology on this expansion line, i.e. close to the final air outlet.

According to another variant of the invention, the second heat exchangers can comprise direct-contact heat exchangers and heat exchangers without direct contact. In this variant, the second direct-contact heat exchangers are preferably positioned among the last heat exchangers of the expansion line, preferably in the last stages of the expansion line. This provides a better compromise between thermal efficiency and matter transfer allowing to increase the gas mass flow rate before entering the expansion means.

According to an embodiment of the invention, the heat exchangers without direct contact can be (welded or not) plate exchangers and/or shell-and-tube exchangers.

According to another embodiment of the invention, the direct-contact heat exchangers can be packed columns with structured or random packing and/or tray columns.

According to an implementation of the invention, the system can comprise at least one means of separating the gas and the liquid. The separation means can be arranged after at least a first heat exchanger so as to eliminate condensation traces that might appear upon cooling of the gas and damage the other equipments of the system, notably the next compression stages.

Advantageously, several gas compression and/or several gas expansion means can be used, preferably at least three. Using staged compression and/or expansion means allows the efficiency and the performances of the system to be improved.

According to an implementation of the invention, several first heat exchangers can be used, preferably at least a first heat exchanger after each compression means. Thus, the gas is cooled before storage of the compressed gas or before it enters the next compression means. If it is stored, the lower storage temperature induces lower storage costs. If it enters a next compression means, the efficiency of this compression means is higher when the temperature is lower.

Preferably, several separation means can be used, preferably at least one separation means after each first heat exchanger. Thus, condensation traces likely to appear upon cooling of the gas are eliminated, which allows to avoid damaging the rest of the system and notably the next compression stages.

Advantageously, several second heat exchangers can be used, preferably at least a second heat exchanger upstream from each expansion means. The temperature of the gas is thus raised upstream from the expansion means, thereby avoiding too low and harmful temperatures at the expansion means outlet. Furthermore, the higher the temperature, the more energy in the gas and therefore the higher the energy release.

The invention also relates to an energy storage and recovery method wherein the following steps are carried out:
a) compressing a gas,
b) cooling a compressed gas by heat exchange with a cold liquid and storing the hot liquid at the heat exchanger outlet,
c) storing the cooled compressed gas,
d) heating the cooled compressed gas by means of a heat exchanger using the hot liquid stored in step c) and storing the cold liquid,
e) expanding the compressed gas.

In this implementation, at least one heat exchange carried out in step b) occurs without direct contact between the liquid and the gas. Thus, the heat recovery efficiency is optimized and no mass transfer between the liquid and the gas can occur, which avoids adding liquid to the condensation water formed in the gas.

Furthermore, at least one heat exchange carried out in step d) occurs through direct contact between the liquid and the gas. Using this type of heat exchange allows to recover part of the liquid in the gas, which allows to increase the gas mass flow rate and therefore the performance of the expansion means.

Advantageously, the gas may be air, preferably air taken from the ambient medium. Thus, the costs related to gas production, conditioning and logistics are eliminated.

Preferably, the liquid may be water. Indeed, water is an inexpensive heat transfer fluid, which provides an excellent compromise.

According to an embodiment of the invention, between step b) and step c), step b-bis) consisting in separating the cooled compressed gas and the condensed liquid can be carried out, and the liquid condensed (step b-bis)) between step b) and step c) can be stored. Thus, traces of the condensed liquid likely to form during cooling of the gas in step b) can be eliminated.

According to a variant of the invention, at least one of steps a), b) and b-bis) (for example, several times step a) or several times steps a) and b) or several times steps a), b) and b-bis)) can be carried out several times prior to moving on to the next step. Thus, the performances of the method are improved by the fact that these various steps can be staged.

According to another variant of the invention, at least one of steps d) and e) can be carried out several times (for example, several times step d) or several times steps d) and e)). The expansion means are thus staged, which allows to maximize the energy recovery efficiency and/or the gas is heated in several steps, for example before each expansion step, so that the temperature of the gas at the expansion means inlet is close to an optimum value.

According to an implementation of the invention, each heat exchange of step d) between the liquid and the gas can occur by direct contact between the liquid and the gas. The expansion line is thus simplified by using a single exchanger technology on this line.

According to a variant embodiment of the invention, the heat exchanges of step d) between the liquid and the gas can occur by means of direct-contact heat exchangers and heat exchangers without direct contact, the direct-contact heat exchangers being positioned among the last heat exchangers, preferably in the last expansion steps. Heat recovery is thus optimized by heat exchanges without direct contact, then the mass flow rate increase at the compression means inlet is maximized, as well as the efficiency thereof, by direct-contact heat exchanges. This configuration is an optimum compromise allowing the overall efficiency of the system to be maximized.

According to an implementation of the method according to the invention, at least one heat exchange of step b) and at least one heat exchange of step d) can be replaced by a heat exchange between a fixed bed of heat storage particles and the gas. For example, the compression line can comprise at least one heat exchanger without direct contact between the liquid and the gas, and at least one Thermocline type heat exchanger between a fixed bed of heat storage particles and the gas; the expansion line can for example comprise at least one heat exchanger with direct contact between the liquid and the gas, and at least one Thermocline type heat exchanger between a fixed bed of heat storage particles and the gas, this Thermocline type exchanger being merged with that of the compression line. In Thermocline type heat exchangers, the heat of the compressed gas is stored in the heat storage particles during at least one step b). The heat thus stored in the heat storage particles is subsequently released to the compressed gas during at least one step d). The particle bed being fixed, the gas needs to be circulated in order to store or release the heat in the heat storage particles. Thus, if a Thermocline type heat exchanger is used on the compression line, it is also used on the expansion line. Using this type of exchanger involves the advantage of being simple to implement and it reduces the costs by limiting the number of heat exchangers, a single exchanger being used as the first and second heat exchanger, thus limiting the pipes and the throttling/pumping systems required for gas/liquid type exchanges (direct-contact heat exchangers and heat exchangers without direct contact). Besides, the heat storage particles can be made from inexpensive materials.

According to an embodiment of the invention, the heat exchange without direct contact of step b) can be achieved by means of at least one (welded or not) plate exchanger and/or at least one shell-and-tube exchanger.

According to a variant embodiment of the invention, the direct-contact heat exchange of step d) can be achieved, at least partly, through a packed column with structured or random packing, and/or a tray column.

Other features and advantages of the method and the system according to the invention will be clear from reading the description hereafter of non-limitative example embodiments, with reference to the accompanying figures described hereafter.

Examples 1 to 3 are variants of the state of the art. Examples 4 and 5 are variant embodiments according to the invention.

The examples are carried out with 4 compression stages and 4 expansion stages, but this number of stages is not limitative.

In the description of these various examples, the same equipments (compressors for the compression means and turbines for the expansion means) are used for compression and expansion of the air. The characteristics of the compressors and turbines used are given in the table below.

| | Pressure | Efficiency |
|---|---|---|
| | ratio | (%) |
| Compressors | | |
| K-101 | 5.22 | 84.3 |
| K-102 | 4.435 | 83 |
| K-103 | 2.7974 | 81.4 |
| K-104 | 2.3422 | 71.8 |
| Turbines | | |
| EX-201 | 0.59 | 78 |
| EX-202 | 0.51 | 80.50 |
| EX-203 | 0.15 | 83 |
| EX-204 | 0.1861 | 85.50 |

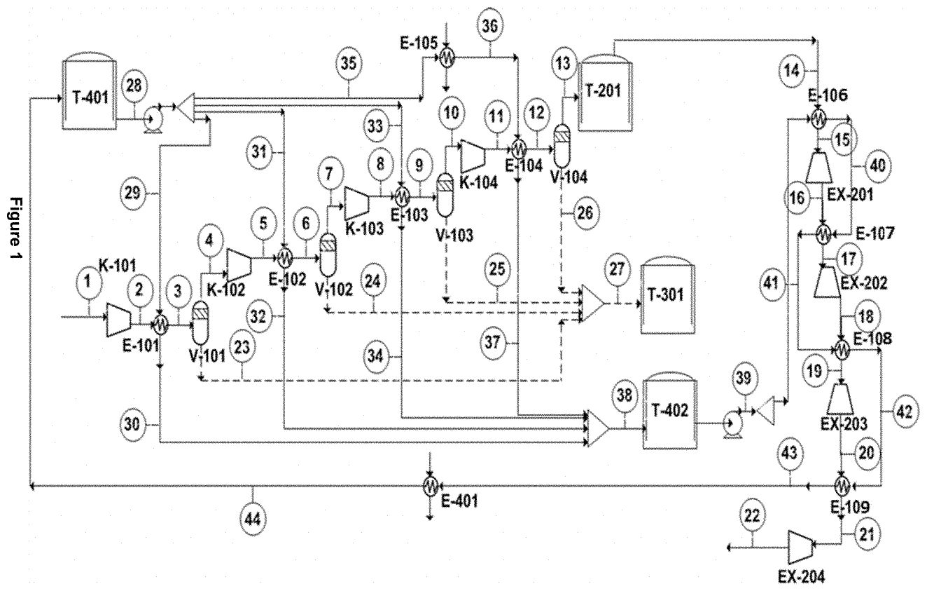

### Example 1: According to the Prior Art (FIG. 1)

This example can correspond to the system or to the method with water as the thermal fluid instead of a saline solution as described in patent DE-10-2010/055,750 A1.

51,350 kg/h outside air (flow 1), at a temperature of 20° C. and a pressure of 1,014 bar, containing 4.2 mol % water, is fed to a compression stage K-101 from where it flows at a higher pressure and at a higher temperature (flow 2).

This flow 2 is then cooled to 50° C. in an exchanger E-101 without direct contact by water at 40° C. (flow 29). The water leaves the exchanger at a higher temperature (flow 30) and it is sent to a hot liquid storage means T-402.

The cooled air is sent to a gas/liquid separator V-101 that separates the humidity of the condensed air (flow 23) from the air (flow 4). This condensed water is thereafter sent to a condensed liquid storage means T-301.

The air then flows into a second compression stage K-102 which it leaves at a higher pressure and temperature (flow 5). It is then cooled in an exchanger without direct contact E-102 with cold water (flow 31).

The hot water leaving the exchanger (flow 32) is sent to hot liquid storage means T-402.

The cooled air (flow 6) enters a gas/liquid separator V-102 separating the condensed humidity (flow 24) from the cold air (flow 7). The condensed humidity is sent to condensed liquid storage means T-301.

The cooled air (flow 7) enters a third compression stage K-103 which it leaves (flow 8) at a higher pressure and temperature. It is then cooled in an exchanger without direct contact E-103 with cold water (flow 33).

This hot water is then sent to hot liquid storage means T-402.

The cold air enters a gas/liquid separator V-103 where the condensed humidity (flow 25) is separated from the air (flow 10). This condensed humidity is then sent to condensed liquid storage means T-301.

The cold air (10) leaving separator V-103 then enters a last compression stage K-104 which it leaves (flow 11) at a higher pressure and temperature.

It is subsequently cooled in an exchanger without direct contact E-104 with cold water (flow 36). This flow 36 can be cooled, by means of an exchanger E-105, to a lower temperature than that of the water used for cooling in heat exchangers E-101, E-102 and E-103. The hot water (flow 37) leaving exchanger E-104 is sent to hot liquid storage means T-402.

The cold air (flow 12) enters a gas/liquid separator V-104 where the condensed humidity (flow 26) is sent to condensed liquid storage means T-301.

The cold air (flow 13), 50,000 kg/h, leaving at a pressure of 136.15 bars and at a temperature of 30° C., is sent into compressed gas storage means T-201, which may be either natural or artificial. It now contains only 300 ppm water. The power consumption for the compression step is 10.9 MW. Cooling of the air during compression requires 54,689 kg/h coolant and condensation of the humidity of the air represents an amount of 1.35 t/h to be stored or eliminated.

Considering these significant amounts of water, the water stored in condensed liquid storage means T-301 is regularly drained.

During electricity production, the stored air (flow 14) is sent from compressed gas storage means T-201 to an exchanger without direct contact E-106 with the hot water (flow 39) from hot liquid storage means T-402. Exchanger E-106 can be identical to exchanger E-104 used for cooling. Alternatively, exchanger E-106 and exchanger E-104 can be merged to save on equipment costs. This is possible due to the cyclic operation of the system: exchanger E-104/E-106 is used either during compression, or during expansion.

The hot air (flow 15) enters a turbine EX-201 where it undergoes expansion. The cooled water (flow 40) leaving exchanger E-106 is sent to exchanger without direct contact E-107 where it heats the cooled expanded air (flow 16). This heated air (flow 17) is sent to a second turbine EX-202 where it is expanded to a lower pressure (flow 18).

The cooled water (flow 41) leaving exchanger E-107 is sent to exchanger without direct contact E-108 where it heats the air leaving turbine EX-202, which is then heated (flow 19). This hot air is then sent to a third turbine EX-203 where it is expanded to a lower pressure (flow 20).

The less hot water (flow 42) leaving exchanger E-108 is sent to another exchanger without direct contact E-109. This exchanger is used for heating the air (flow 20) leaving turbine EX-203 prior to entering (flow 21) the last turbine EX-204.

After final expansion, the air is released to the atmosphere (flow 22) at a pressure of 1.02 bar and a temperature of 10° C. The water used for the various air heating cycles prior to expansion, which leaves exchanger E-109 (flow 43), is at a final temperature of 126° C.

Prior to being recycled, this water needs to be cooled, for example by a water exchanger or by an air cooler. The required cooling power is 5.5 MWth, i.e. a power consumption of 38.7 kWe.

The power produced by the successive expansions is 5.2 MWe.

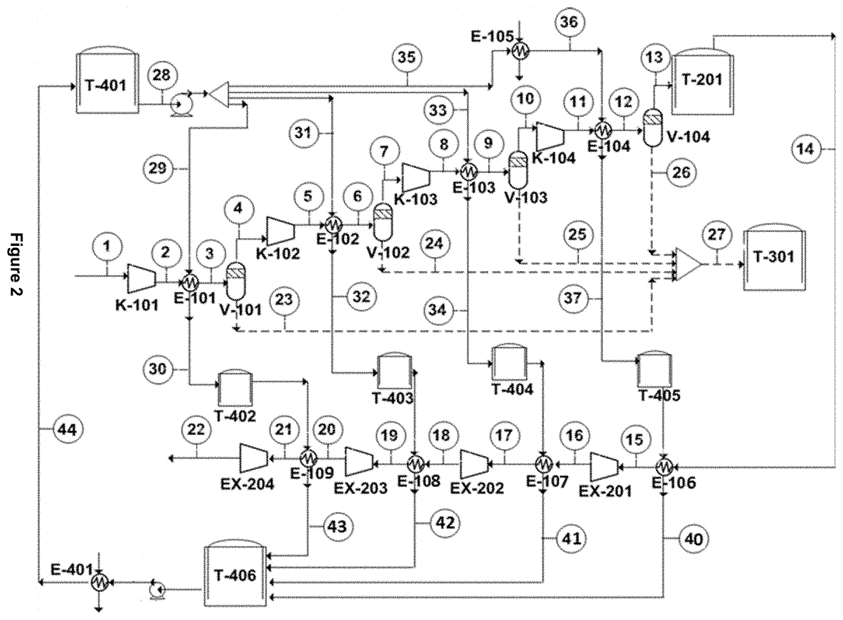

### Example 2: According to the Prior Art (FIG. 2)

This example describes a system or a method using water as the thermal fluid instead of molten salts as described in patent US-2011/0,016,864 A1.

51,350 kg/h outside air (flow 1), at a temperature of 20° C. and a pressure of 1,014 bar, containing 4.2 mol % water, is fed to a compression stage K-101 from where it flows at a higher pressure and at a higher temperature (flow 2).

This flow 2 is then cooled to 50° C. in a heat exchanger E-101 without direct contact (flow 3) by water at 40° C. (flow 29). The water leaves the exchanger at a higher temperature (flow 30) and it is sent to a hot liquid storage means T-402.

The humidity of the cooled air undergoes condensation (flow 23). A separator V-101 allows to separate the air (flow 4) from the condensed humidity (flow 23). This condensed water is thereafter sent to a condensed liquid storage means T-301.

The air then flows into a second compression stage K-102 which it leaves at a higher pressure and temperature (flow 5).

It is then cooled in an exchanger without direct contact E-102 with cold water (flow 31). The hot water leaving the exchanger (flow 32) is sent to a hot liquid storage means T-403. The cooled air (flow 6) enters a gas/liquid separator V-102 separating the condensed humidity (flow 24) from the cold air (flow 7).

The condensed humidity is sent to condensed liquid storage means T-301.

The cooled air (flow 7) enters a third compression stage K-103 which it leaves (flow 8) at a higher pressure and temperature.

It is then cooled in an exchanger without direct contact E-103 with cold water (flow 33).

The hot water (flow 34) at the outlet of exchanger E-103 is then sent to a hot liquid storage means T-404.

The cold air enters a gas/liquid separator V-103 where the condensed humidity (flow 25) is separated from the air (flow 10). This condensed humidity is then sent to condensed liquid storage means T-301.

The cold air (10) leaving separator V-103 then enters a last compression stage K-104 which it leaves (flow 11) at a higher pressure and temperature.

It is subsequently cooled in an exchanger without direct contact E-104 with cold water (flow 36). This flow 36 can be cooled, by means of a heat exchanger E-105, to a lower temperature than that of the water used in exchangers E-101, E-102 and E-103. The hot water (flow 37) leaving exchanger E-104 is sent to a hot liquid storage means T-405.

The cold air (flow 12) enters a gas/liquid separator V-104 where the condensed humidity (flow 26) is sent to condensed liquid storage means T-301.

The cold air (flow 13), 50,000 kg/h, leaving at a pressure of 136.15 bars and at a temperature of 30° C., is sent into a compressed gas storage means T-201, which may be either natural or artificial. It now contains only 300 ppm water. The power consumption for the compression step is 10.9 MW.

As in the previous example, cooling of the air during compression requires 54,689 kg/h coolant and condensation of the humidity of the air represents an amount of 1.35 t/h to be stored or eliminated.

As in Example 1, the condensation water stored in condensed liquid storage means T-301 is regularly drained.

During electricity production, the stored air (flow 14) is sent from compressed gas storage means T-201 to an exchanger without direct contact E-106 with the hot water from hot liquid storage means T-405. Exchanger E-106 can be the same as exchanger E-104 used for cooling. Alternatively, exchangers E-106 and E-104 can be merged to save on equipment costs. This is possible due to the cyclic operation of the system: it is either used to compress the air, or to expand it.

The hot air (flow 15) enters a turbine EX-201 where it undergoes expansion. The cooled water (flow 40) leaving exchanger E-106 is sent to a cold liquid storage means T-406.

The air leaving turbine EX-201 is sent (flow 16) to exchanger without direct contact E-107 where it is heated (flow 17) by water from hot liquid storage means T-404.

The cooled water (flow 41) is sent to cold liquid storage means T-406. This heated air (flow 17) is sent to a second turbine EX-202 where it is expanded to a lower temperature and pressure (flow 18).

It is then heated in heat exchanger without direct contact E-108 by water from hot liquid storage means T-403.

The cooled water (flow 42) leaving exchanger E-108 is sent to cold liquid storage means T-406. The heated air (flow 19) is sent to a turbine EX-203 where it is expanded to a lower pressure (flow 20).

This cold air is heated by hot water from hot liquid storage means T-402 in exchanger without direct contact E-109. This cooled water (flow 43) is sent to cold liquid storage means T-406.

The heated air (flow 21) is then sent to a last turbine EX-204 to be expanded to a lower pressure (flow 22).

After final expansion, the air, 50,000 kg/h, is released to the atmosphere (flow 22) at a pressure of 1.02 bar and a temperature of 17° C.

The water used for the various air heating cycles prior to expansion through exchangers E-106, E-107, E-108 and E-109 is at a final temperature of 129° C.

Prior to being recycled, this water needs to be cooled, for example by a water exchanger or by an air cooler. The required cooling power is 4.2 MWth, i.e. a power consumption of 31 kWe.

The power produced by the successive expansions is 5.4 MWe.

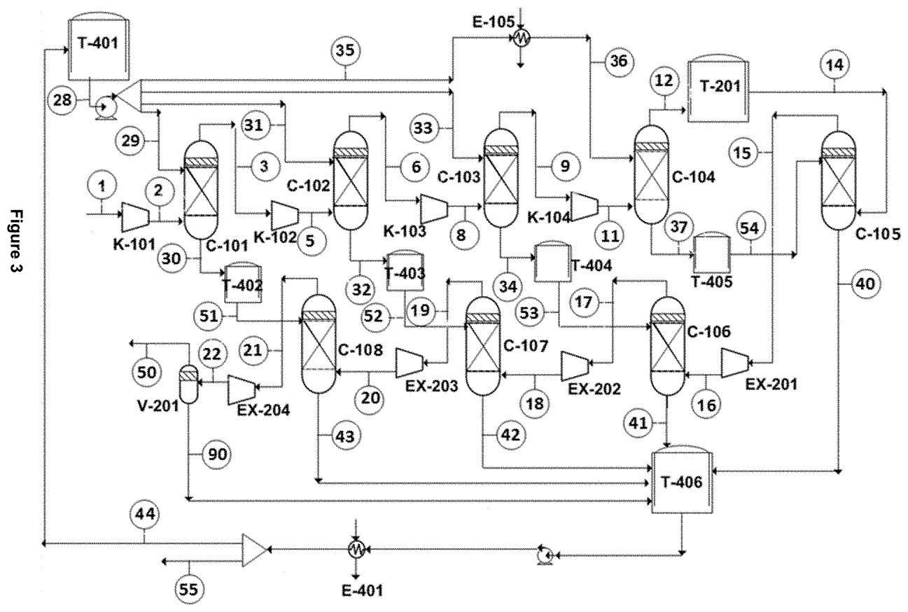

### Example 3: According to the Prior Art (FIG. 3)

51,350 kg/h outside air (flow 1), at a temperature of 20° C. and a pressure of 1,014 bar, containing 4.2 mol % water, is fed to a compression stage K-101 from where it flows at a higher pressure and at a higher temperature (flow 2).

This flow 2 is then cooled to 50° C. in a direct-contact heat exchanger C-101 by water at 40° C. (flow 21). This heat exchanger C-101 consists of a packed column into which the hot air (flow 2) flows through the bottom of the column. The cold water (flow 21) is injected at the top of the column, thus resulting in a cross-flow: one flow (air) moves upward while the other (water) moves downward. The hot water leaves the column at the bottom at a higher temperature (flow 22) and it is sent to a hot liquid storage means T-402.

The cooled air leaves heat exchanger C-101 at the top (flow 3) and it flows into a second compression stage K-102 which it leaves at a higher pressure and temperature (flow 4). It is then cooled in a direct-contact heat exchanger C-102 with cold water (flow 25). The hot water leaving heat exchanger C-102 in the bottom (flow 26) is sent to a hot liquid storage means T-403.

The cooled air (flow 5) enters a third compression stage K-103 which it leaves (flow 6) at a higher pressure and temperature. It is then cooled in a direct-contact heat exchanger C-103 with cold water (flow 29). This hot water (flow 30) is then sent to a hot liquid storage means T-404.

The cold air (flow 7) leaves heat exchanger C-103 at the top and it flows into a last compression stage K-104 which it leaves (flow 8) at a higher pressure and temperature. It is then cooled in a direct-contact heat exchanger C-104 with cold water (flow 34). This flow 34 can be cooled, by means of a heat exchanger E-105, to a lower temperature than the water used in heat exchangers C-101, C-102 and C-103.

The hot water (flow 35) leaving the bottom of heat exchanger C-104 is then sent to a hot liquid storage means T-405.

The cold air (flow 9), 50,000 kg/h, leaving at a pressure of 134.34 bars and at a temperature of 30° C., is sent into a compressed gas storage means T-201, which may be either natural or artificial. It now contains only 320 ppm water. The power consumption for the compression step is 10.9 MW, identical to Examples 1 and 2.

In this implementation example, there is no condensed water flow. On the other hand, the humidity of the air adds up to the water injected for cooling so that, after compression, more water is collected at the outlet than has been initially injected.

In Example 3, 178,338 kg/h water is injected for cooling and 179,715 kg/h leaves the process, i.e. 1,377 kg/h more than the initially injected amount. All the condensed humidity has been transferred to the coolant.

During electricity production, the stored air (flow 14) is sent from compressed gas storage means T-201 to a direct-contact heat exchanger C-105 with the hot water (flow 54) from hot liquid storage means T-405. Heat exchanger C-105 can be identical to exchanger C-104. Alternatively, heat exchangers C-104 and C-105 can be merged to save on equipment costs. This is possible due to the cyclic operation of the system: it is either used during compression, or during expansion.

The hot air (flow 15) leaves the column at the top and it enters a turbine EX-201 where it undergoes expansion.

The cooled water (flow 40) leaving the bottom of exchanger C-105 is sent to a cold liquid storage means T-406.

The air leaving turbine EX-201 is sent (flow 16) to direct-contact heat exchanger C-106 where it is heated by water circulating in a counter-current flow from hot liquid storage means T-404 (flow 53).

The cooled water (flow 41) is sent to cold liquid storage means T-406.

The heated air (flow 17) is sent to a second turbine EX-202 where it is expanded to a lower pressure (flow 18).

It is then heated by direct-contact heat exchanger C-107 by water (flow 52) from hot liquid storage means T-403.

The cooled water (flow 42) leaving the bottom of heat exchanger C-107 is sent to cold liquid storage means T-406.

The heated air (flow 19) is sent to a turbine EX-203 where it is expanded to a lower pressure (flow 20).

This cold air is heated by hot water (flow 51) from hot liquid storage means T-402 in direct-contact heat exchanger C-108.

This cooled water (flow 43) is sent to cold liquid storage means T-406.

The heated air (flow 21) is then sent to a last turbine EX-204 to be expanded to a lower pressure (flow 22). This cold air is thereafter sent to a gas/liquid separator V-201 in order to separate the air (flow 50) from the liquid water that may be present (flow 90). This water is sent to cold liquid storage means T-406.

After final expansion, the air, 50,800 kg/h, is released to the atmosphere (flow 50) at a pressure of 1.02 bar and a temperature of 22° C.

The water used for the various air heating cycles prior to expansion through exchangers C-105, C-106, C-107 and C-108 is at a final temperature of 65.7° C.

Prior to being recycled, this water needs to be cooled, for example by a water exchanger or by an air cooler. The required cooling power is 5.3 MWth, i.e. a power consumption of 74.5 kWe.

The power produced by the successive expansions is 4.45 MWe.

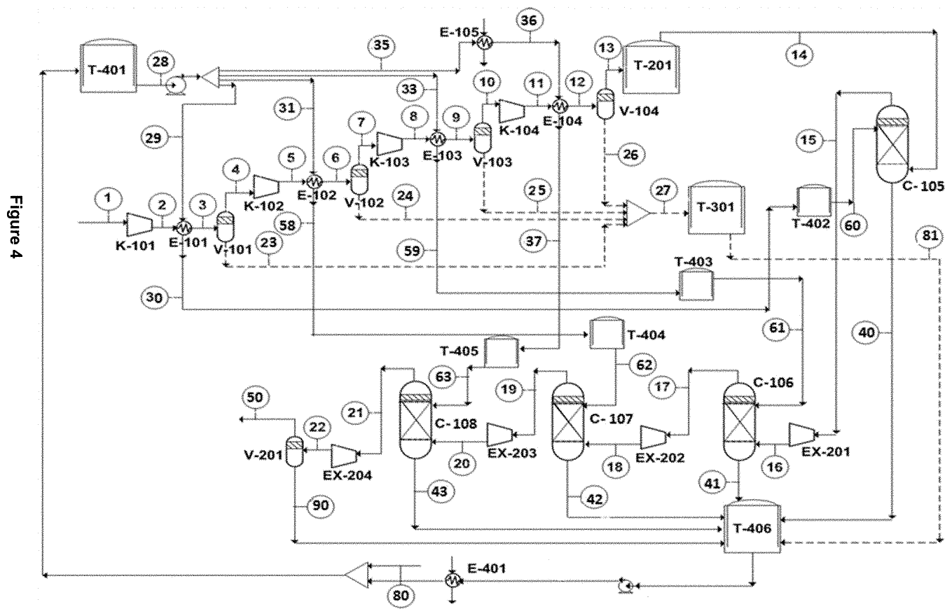

### Example 4: According to the Invention (FIG. 4)

51,350 kg/h outside air (flow 1), at a temperature of 20° C. and a pressure of 1,014 bar, containing 4.2 mol % water, is fed to a compression stage K-101 from where it flows at a higher pressure and at a higher temperature (flow 2).

This flow 2 is cooled to 50° C. in a heat exchanger E-101 without direct contact (flow 3) by water at 40° C. (flow 29). The water leaves the exchanger at a higher temperature (flow 30) and it is sent to a hot liquid storage means T-402.

The humidity of the cooled air undergoes condensation (flow 23). A separation means (for example a gas/liquid separator) V-101 allows to separate the air (flow 4) from the condensed liquid. This condensed water is thereafter sent to a condensed liquid intermediate storage means T-301.

The air flows into a second compression stage K-102 which it leaves at a higher pressure and temperature (flow 5). It is then cooled in a heat exchanger without direct contact E-102 with cold water (flow 31).

The hot water leaving exchanger E-102 (flow 58) is sent to a hot liquid storage means T-404.

The cooled air (flow 6) enters a gas/liquid separator V-102 separating the condensed humidity (flow 24) from the cold air (flow 7). The condensed humidity is sent to condensed liquid intermediate storage means T-301.

The cooled air (flow 7) enters a third compression stage K-103 which it leaves (flow 8) at a higher pressure and temperature. It is then cooled in a heat exchanger without direct contact E-103 with cold water (flow 33). The water leaving exchanger E-103 (flow 59) is then sent to a hot liquid storage means T-403.

The cold air enters a gas/liquid separator V-103 where the condensed humidity (flow 25) is separated from the air (flow 10). This condensed humidity is then sent to condensed liquid storage means T-301.

The cold air (flow 10) leaving separator V-103 then enters a last compression stage K-104 which it leaves (flow 11) at a higher pressure and temperature. It is then cooled in a heat exchanger without direct contact E-104 with cold water (flow 36). This flow 36 can be cooled, by means of a heat exchanger E-105, to a lower temperature than that of the water used in exchangers E-101, E-102 and E-103.

The hot water (flow 37) leaving heat exchanger E-104 is sent to a hot liquid storage means T-405.

The cold air (flow 12) enters a gas/liquid separator V-104 where the condensed humidity (flow 26) is sent to condensed liquid storage means T-301.

The cold air (flow 13), 50,000 kg/h, leaving at a pressure of 136.15 bars and at a temperature of 30° C., is sent into a compressed gas storage means T-201, which may be either natural or artificial. It now contains only 300 ppm water. The power consumption for the compression step is 10.9 MW.

As in Examples 1 and 2, cooling of the air during compression requires 54,689 kg/h coolant and condensation of the humidity of the air represents an amount of 1.35 t/h to be stored or eliminated.

The condensation water stored in condensed liquid intermediate storage means T-301 is sent via flow 81 to cold liquid storage means T-406. Thus, the condensation water is recovered and it can be used as heat-transfer fluid.

During electricity production, the stored air (flow 14) is sent from compressed gas storage means T-201 to a direct-contact heat exchanger C-205 with the hot water (flow 60) from hot liquid storage means T-402.

The hot air (flow 15) leaves heat exchanger C-205 at the top and it enters a turbine EX-201 where it undergoes expansion.

The cooled water (flow 40) leaving heat exchanger C-205 at the bottom is sent to a cold liquid storage means T-406.

The air leaving turbine EX-201 is sent (flow 16) to direct-contact heat exchanger C-206 where it is heated by water circulating in a counter-current flow from hot liquid storage means T-403 (flow 61). The cooled water (flow 41) is sent to cold liquid storage means T-406.

This heated air (flow 17) is sent to a second turbine EX-202 where it is expanded to a lower pressure (flow 18).

It is then heated in direct-contact heat exchanger C-206 by water (flow 62) from hot liquid storage means T-404.

The cooled water (flow 42) leaving heat exchanger C-206 at the bottom is sent to cold liquid storage means T-406.

The heated air (flow 19) is sent to a turbine EX-203 where it is expanded to a lower pressure (flow 20).

This cold air is heated by hot water (flow 63) from hot liquid storage means T-405 in direct-contact exchanger C-208.

This cooled water (flow 43) is sent to cold liquid storage means T-406.

The heated air (flow 21) is then sent to a last turbine EX-204 to be expanded to a lower pressure (flow 22).

This cold air is thereafter sent to a gas/liquid separator V-201 in order to separate the air (flow 50) from the liquid water that may be present (flow 90). This water is sent to cold liquid storage means T-406.

After final expansion, the air, 52,240 kg/h, is released to the atmosphere (flow 50) at a pressure of 1.02 bar and a temperature of 39° C.

The water used for the various air heating cycles through heat exchangers C-205, C-206, C-207 and C-208 and stored in cold liquid storage means T-406 is at a final temperature of 93.3° C.

Prior to being recycled, this water needs to be cooled, for example by a water exchanger or by an air cooler. The required cooling power is 3.3 MWth, i.e. a power consumption of 31.6 kWe.

The power produced by the successive expansions is 5.6 MWe.

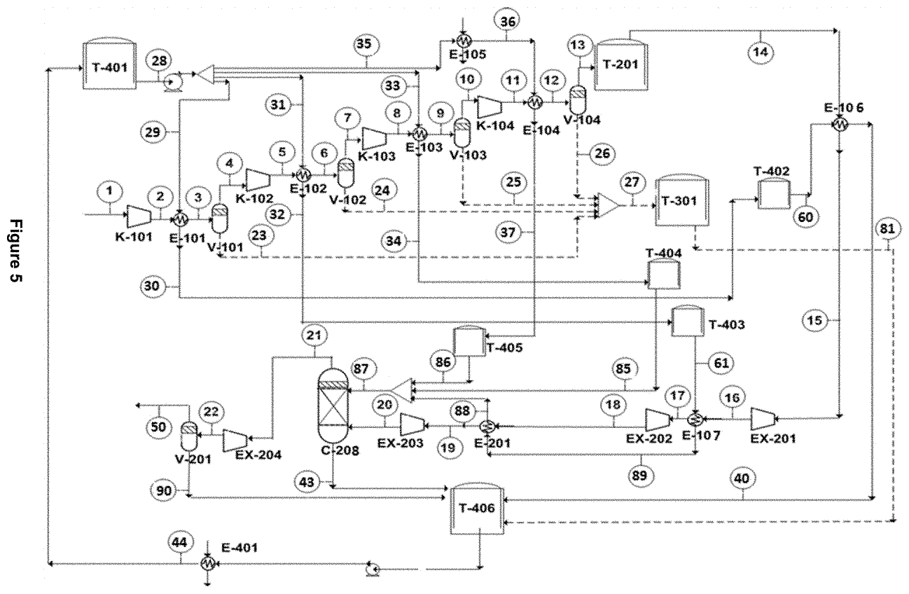

### Example 5: According to the Invention (FIG. 5)

51,350 kg/h outside air (flow 1), at a temperature of 20° C. and a pressure of 1,014 bar, containing 4.2 mol % water, is fed to a compression stage K-101 from where it flows at a higher pressure and at a higher temperature (flow 2).

This flow 2 is then cooled to 50° C. in a heat exchanger E-101 without direct contact (flow 3) by water at 40° C. (flow 29).

The water leaves the exchanger at a higher temperature (flow 30) and it is sent to a hot liquid storage means T-402.

The humidity of the cooled air undergoes condensation (flow 23) and it is separated from the air (flow 4) in a gas/liquid separator V-101. This condensed water is thereafter sent to a condensed liquid intermediate storage means T-301.

The air flows into a second compression stage K-102 which it leaves at a higher pressure and temperature (flow 5). It is then cooled in a heat exchanger without direct contact E-102 with cold water (flow 31).

The hot water leaving exchanger E-102 (flow 32) is sent to a hot liquid storage means T-403.

The cooled air (flow 6) enters a gas/liquid separator V-102 separating the condensed humidity (flow 24) from the cold air (flow 7). The condensed humidity is sent to condensed liquid storage means T-301.

The cooled air (flow 7) enters a third compression stage K-103 which it leaves (flow 8) at a higher pressure and temperature.

It is then cooled in a heat exchanger without direct contact E-103 with cold water (flow 33). The water coming out hot from heat exchanger E-103 (flow 34) is then sent to hot liquid storage means T-404.

The cold air enters a gas/liquid separator V-103 where the condensed humidity (flow 25) is separated from the air (flow 10). This condensed humidity is then sent to condensed liquid storage means T-301.

The cold air (flow 10) leaving separator V-103 then enters a last compression stage K-104 which it leaves (flow 11) at a higher pressure and temperature.

It is then cooled in a heat exchanger without direct contact E-104 with cold water (flow 36). This flow 36 can be cooled, by means of a heat exchanger E-105, to a lower temperature than that of the water used in heat exchangers E-101, E-102 and E-103.

The hot water (flow 37) leaving heat exchanger E-104 is sent to a hot liquid storage means T-405.

The cold air (flow 12) enters a gas/liquid separator V-104 where the condensed humidity (flow 26) is sent to condensed liquid storage means T-301.

The cold air (flow 13), 50,000 kg/h, leaving at a pressure of 136.15 bars and at a temperature of 30° C., is sent into a compressed gas storage means T-201, which may be either natural or artificial. It now contains only 300 ppm water. The power consumption for the compression step is 10.9 MW.

The condensation water stored in condensed liquid intermediate storage means T-301 is sent via flow 81 to cold liquid storage means T-406. Thus, the condensation water is recovered and it can be used as heat-transfer fluid.

During electricity production, the stored air (flow 14) is sent from compressed gas storage means T-201 to a heat exchanger without direct contact E-106 with the hot water (flow 60) from hot liquid storage means T-402. Heat exchanger E-106 can be identical to exchanger E-104. Alternatively, exchangers E-106 and E-104 can be merged to save on equipment costs. This is possible due to the cyclic operation of the process: it is used either during compression, or during expansion.

The hot air (flow 15) enters a turbine EX-201 where it undergoes expansion.

The cooled water (flow 40) leaving heat exchanger E-106 is sent to cold liquid storage means T-406.

The air leaving turbine EX-201 is sent (flow 16) to heat exchanger E-107 without direct contact where it is heated (flow 17) by water coming from hot liquid storage means T-403 (flow 61). The cooled water (flow 89) is sent to another heat exchanger without direct contact E-108.

This heated air (flow 17) is sent to a second turbine EX-202 where it is expanded to a lower pressure (flow 18).

It is then heated in a heat exchanger without direct contact E-208 by water (flow 89) from exchanger E-107.

The heated air (flow 19) is sent to a turbine EX-203 where it is expanded to a lower pressure (flow 20).

This cold air is heated in a direct-contact exchanger C-201 by hot water (flow 87) from an in-line mixer, mixing the hot waters from exchanger E-201 (flow 88), from hot liquid storage means T-404 (flow 85) and from hot liquid storage means T-405 (flow 86).

The cooled water (flow 43) leaving the bottom of heat exchanger C-208 is sent to cold liquid storage means T-406.

The heated air (flow 21) is then sent to a last turbine EX-204 to be expanded to a lower pressure (flow 22).

This expanded air is thereafter sent to a gas/liquid separator V-201 in order to separate the air (flow 50) from the liquid water that may be present (flow 90). This water is sent to cold liquid storage means T-406.

After final expansion, the air, 52,900 kg/h, is released to the atmosphere (flow 50) at a pressure of 1.02 bar and at a temperature of 43° C.

The hot water used for the various air heating cycles through heat exchangers E-106, E-107, E-201 and C-208 and stored in cold liquid storage means T-406 is at a final temperature of 84.2° C. Prior to being recycled, this water needs to be cooled, either by a water exchanger or by an air cooler. The required cooling power is 2.7 MWth, i.e. a power consumption of 29 kWe.

The power produced by the successive expansions is 5.7 MWe.

The summary table below gives the main results of the various examples.

| | Electricity | Required cooling |
|---|---|---|
| Embodiment | produced (MW) | power (E-401) (MW) |
| Example 1 (Prior art) | 5.4 | 4.2 |
| Example 2 (Prior art) | 5.2 | 5.5 |
| Example 3 (Prior art) | 4.5 | 5.3 |
| Example 4 (According to the | 5.6 | 3.3 |
| invention) | | |
| Example 5 (According to the | 5.7 | 2.7 |
| invention) | | |

Examples 4 and 5 according to the invention show a produced electricity gain in relation to Examples 1 to 3 of the prior art, whereas the required cooling power is significantly lower. Examples 1 to 3 according to the prior art require between 4.2 and 5.5 MW cooling power, whereas Examples 4 and 5 only need between 2.7 and 3.3 MW. The overall efficiency of the system according to the invention is thus greatly improved in relation to the systems of the prior art, on the one hand with the increase in the electricity produced and, on the other hand, with the decrease in the required cooling power.

The configuration of Example 5 is particularly interesting because it represents the best efficiency with both the largest amount of electricity produced and the lowest required cooling power. This result can be explained by:
the recovery of liquid in the gas, on the expansion line, which allows the mass flow rate of the gas to be increased at the turbine inlet,
a good compromise between the use of exchangers with direct contact and without direct contact, on the expansion line, notably when using the direct-contact exchangers among the last exchangers of the expansion line, in the last expansion stages. This allows to maximize the thermal energy recovery and to increase the mass flow rate of the gas,
the use of exchangers without direct contact on the compression line to limit the recovery of liquid on the expansion line.

1. A compressed-gas energy storage and recovery system comprising:
at least one gas compression means (K-101, K-102, K-103, K-104),
at least one means of storing the compressed gas (T-201),
at least one means of expanding the compressed gas (EX-201, EX-202, EX-203, EX-204) to generate energy,
at least a first heat exchanger (E-101, E-102, E-103, E-104), the first heat exchanger being arranged downstream from the means of compressing the compressed gas (K-101, K-102, K-103, K-104),
at least a second heat exchanger (E-106, E-107, E-201, C-105, C-106, C-107, C-108, C-208), the second heat exchanger being arranged upstream from the means of expanding the compressed gas (EX-201, EX-202, EX-203, EX-204),
at least one cold liquid storage means (T-406) and at least one hot liquid storage means (T-402, T-403, T-404, T-405),
wherein the first heat exchangers comprise at least one heat exchanger without direct contact and at least one second heat exchanger is a direct-contact heat exchanger, the direct-contact heat exchangers and the heat exchangers without direct contact transferring heat between the gas and the liquid, the direct-contact heat exchangers and the heat exchangers without direct contact being positioned between the cold liquid storage means (T-406) and the hot liquid storage means (T-402, T-403, T-404, T-405).

2. A system as claimed in claim 1, wherein the gas is air.

3. A system as claimed in claim 1, wherein the liquid is water.

4. A system as claimed in claim 1, wherein the first heat exchangers are all heat exchangers without direct contact between the liquid and the gas.

5. A system as claimed in claim 1, wherein the system comprises at least one heat exchanger with a fixed bed of heat storage particles, the heat exchanger with a fixed bed of heat storage particles being configured to be both a first and a second heat exchanger.

6. A system as claimed in claim 1, wherein the second heat exchangers are all heat exchangers with direct contact between the liquid and the gas.

7. A system as claimed in claim 1, wherein the second heat exchangers comprise direct-contact heat exchangers and heat exchangers without direct contact, the second direct-contact heat exchangers being positioned among the last heat exchangers.

8. A system as claimed in claim 1, wherein the heat exchangers without direct contact are (welded or not) plate exchangers and/or shell-and-tube exchangers.

9. A system as claimed in claim 1, wherein the direct-contact heat exchangers are packed columns and/or tray columns.

10. A system as claimed in claim 1, wherein the system comprises at least one means (V-101, V-102, V-103, V-104) of separating the gas and the liquid, the separation means (V-101, V-102, V-103, V-104) being positioned after at least one first heat exchanger (E-101, E-102, E-103, E-104).

11. A system as claimed in claim 1, wherein several gas compression means (K-101, K-102, K-103, K-104) and/or several means (K-101, K-102, K-103, K-104) of expanding the gas are used, preferably at least three.

12. A system as claimed in claim 11, wherein several first heat exchangers (E-101, E-102, E-103, E-104) are used, preferably at least a first heat exchanger (E-101, E-102, E-103, E-104) after each of the compression means (K-101, K-102, K-103, K-104).

13. A system as claimed in claim 12, wherein several separation means (V-101, V-102, V-103, V-104) are used, preferably at least one separation means (V-101, V-102, V-103, V-104) after each of the first heat exchangers (E-101, E-102, E-103, E-104).

14. A system as claimed in claim 11, wherein several second heat exchangers (E-106, E-107, E-201, C-105, C-106, C-107, C-108, C-208) are used, preferably at least a second heat exchanger (E-106, E-107, E-201, C-105, C-106, C-107, C-108, C-208) upstream from each of the expansion means (EX-201, EX-202, EX-203, EX-204).

15. An energy storage and recovery method wherein the following steps are carried out:
a) compressing a gas,
b) cooling a compressed gas by heat exchange with a cold liquid and storing the hot liquid at the outlet of heat exchanger (E-101, E-102, E-103, E-104),
c) storing the cooled compressed gas,
d) heating the cooled compressed gas by means of a heat exchanger using the hot liquid stored in step c) and storing the cold liquid,
e) expanding the compressed gas,
wherein at least one heat exchange carried out in step b) occurs without direct contact between the liquid and the gas, and at least one heat exchange carried out in step d) occurs at least partly by direct contact between the liquid and the gas.

16. A method as claimed in claim 15, wherein the gas is air.

17. A method as claimed in claim 15, wherein the liquid is water.

18. A method as claimed in claim 15 wherein, between step b) and step c), step b-bis) consisting in separating the cooled compressed gas and the condensed liquid is carried out, and the condensed liquid is stored.

19. A method as claimed in claim 15, wherein at least one of steps a), b) and/or b-bis) is carried out several times prior to moving on to the next step.

20. A method as claimed in claim 15, wherein at least one of steps d) and e) is carried out several times.

21. A method as claimed in claim 15, wherein each heat exchange of step d) between the liquid and the gas occurs by direct contact between the liquid and the gas.

22. A method as claimed in claim 15, wherein the heat exchanges of step d) between the liquid and the gas occur by means of direct-contact heat exchangers and heat exchangers without direct contact, the direct-contact heat exchangers being positioned among the last heat exchangers.

23. A method as claimed in claim 19, wherein at least one heat exchange of step b) and at least one heat exchange of step d) are replaced by a heat exchange between a fixed bed of heat storage particles and the gas, the heat of the compressed gas being stored in the heat storage particles during at least one step b), the stored heat of the heat storage particles being released to the compressed gas during at least one step d).

24. A method as claimed in claim 15, wherein the heat exchange without direct contact occurs by means of at least one (welded or not) plate exchanger or of at least one shell-and-tube exchanger.

25. A method as claimed in claim 15, wherein the direct-contact heat exchange occurs at least partly through a packed column or a tray column.
